(19) United States
(12) Patent Application Publication
(10) Pub. No.: US 2017/0032449 A1
(43) Pub. Date: Feb. 2, 2017

(54) System and Method for Automated Generation and Shipment of Greeting Cards to a User

(71) Applicant: ThoughtsOnTime.com, LLC, Houston, TX (US)

(72) Inventor: Reginald Munden, Houston, TX (US)

(21) Appl. No.: 14/812,646

(22) Filed: Jul. 29, 2015

(51) Int. Cl. G06Q 30/06; G06Q 10/08

(52) U.S. Cl. CPC G06Q 30/0635; G06Q 10/083

(57) ABSTRACT

A system and method for automated generation and shipment of greeting cards to a user is described herein. The system can comprise a server memory, and a server processor. The server memory can store a user account, one or more recipients, a plurality of cards, and a greeting card website. The user account can comprise a user address. The recipients can be related to the user account. The server processor that according to instructions from the greeting card website can store a recipient information and one or more events for each of the recipients, provide accessibility to the cards to a user of the user account, and can generate a shipment date for one of the cards. Lastly, the server processor that according to the instructions from the greeting card website can receive a click from a place order button from the user.

### BACKGROUND

This disclosure relates to a system and method for automated generation and shipment of greeting cards to a user.

Traditionally, greeting cards are illustrated cards that contain printed and handwritten messages, which are usually mailed or handed to friends and relatives during special occasions. Selecting and sending a traditional card can be a sincere way of letting a person know that he or she was remembered on their special day. However, such method can also be time consuming, especially if a person needs to send cards to many individuals. Moreover, it can be hard to remember all the special occasions for every acquaintance, friends, and relatives in a timely manner, especially if using mail delivery. With the rise of the Internet, electronic greeting cards became popular, usually via email, as a means of recognizing a person's special occasion. Such method can be effective in letting a recipient know that he was remembered on a special occasion, but these cards lack personal touch of a handwritten message and are perceived as requiring minimal effort. As such it would be useful to have a system and method that automatically reminds the sender of a person's special occasion by delivering a pre-selected card of their choice to them which they then add a personal message and deliver to the recipient.

### SUMMARY

A system and method for automated generation and shipment of greeting cards to a user is described herein. The system can comprise a server memory, and a server processor. The server memory can store a user account, one or more recipients, a plurality of cards, and a greeting card website. The user account can comprise a user address. The recipients can be related to the user account. The server processor that according to instructions from the greeting card website can store a recipient information and one or more events for each of the recipients. Each of the events can comprise an event information and an event date. Moreover, the server processor that according to the instructions from the greeting card website can provide accessibility to the cards to a user of the user account, and can generate a shipment date for one of the cards. Each of the cards can be related to the event information. The shipment date can be calculated according to a predetermined number of days before an event date. Lastly, the server processor that according to the instructions from the greeting card website can receive a click from a place order button from the user. Clicking the place order button causes the card to be shipped. The card is shipped to the user address according to the predetermined number of days that is supplied on the greeting card website.

A method for providing an automated generation and shipment of greeting cards to a user is herein disclosed. The method can comprise the steps of storing a recipient information and one or more events for each of one or more recipients. Each of the events can comprise an event information and an event date. The method can also comprise the steps of providing accessibility to a plurality of cards to the user of a user account, and generating a shipment date for one of the cards. Each of the cards can be related to the event information. The shipment date can be calculated according to a predetermined number of days before an event date. Lastly, the method can comprise the step of receiving a click from a place order button from the user. Clicking the place order button causes the card to be shipped. The card is shipped to a user address according to the predetermined number of days that is supplied on the greeting card website.

### BRIEF DESCRIPTION OF THE DRAWINGS

FIG. 1 illustrates a web-based greeting card system comprising a computer, and one or more server.

FIG. 2 illustrates a schematic diagram of a server according to an embodiment of the present disclosure.

FIG. 3 illustrates a server data store comprising one or more user accounts, and a plurality of cards.

FIG. 4 illustrates each recipient comprising a recipient (identification) ID, recipient information, and one or more events.

FIG. 5 illustrates a main screen of a greeting card website.

FIG. 6 illustrates a recipient screen.

FIG. 7 illustrates an event screen.

FIG. 8 illustrates a select card screen.

FIG. 9 illustrates an exemplary method of selecting a card from a greeting card website.

### DETAILED DESCRIPTION

Described herein is a system and method for automated generation and shipment of greeting cards to a user. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

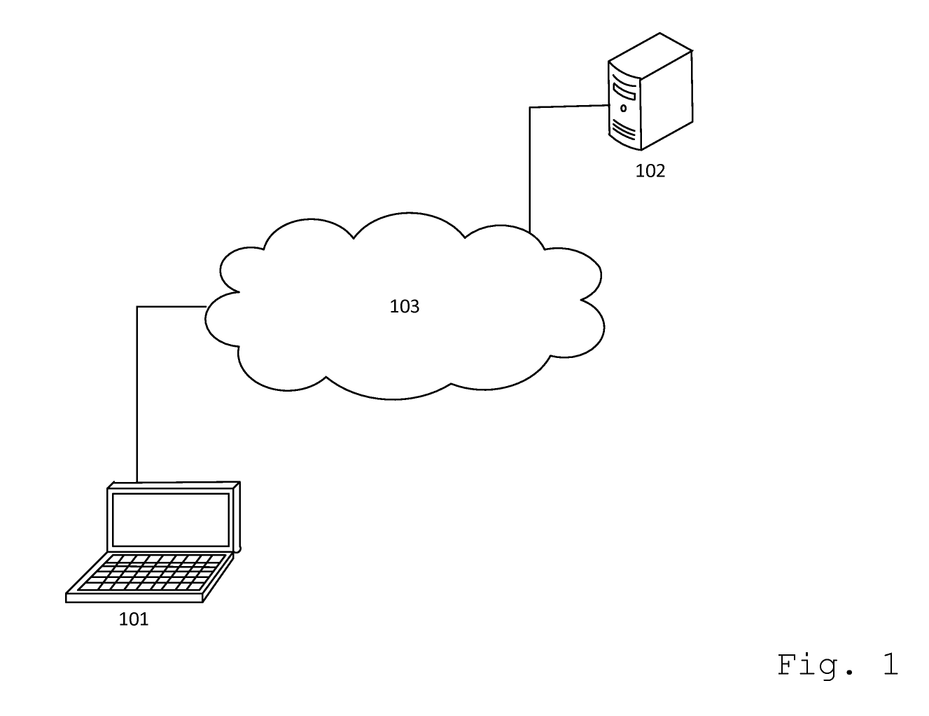

FIG. 1 illustrates a web-based greeting card system 100 comprising a computer 101, and one or more server 102. Computer 101 can be a desktop computer, laptop, tablet, or smartphone. Server 102 represents at least one, but can be many servers, each connected to network 103 capable of performing computational task, and storing data information. Network 103 can be a local area network (LAN), a wide area network (WAN), a piconet, or a combination of LANs, WANs, or piconets. One illustrative LAN is a network within a single business. One illustrative WAN is the Internet. In the preferred embodiment, network 103 will comprise the Internet.

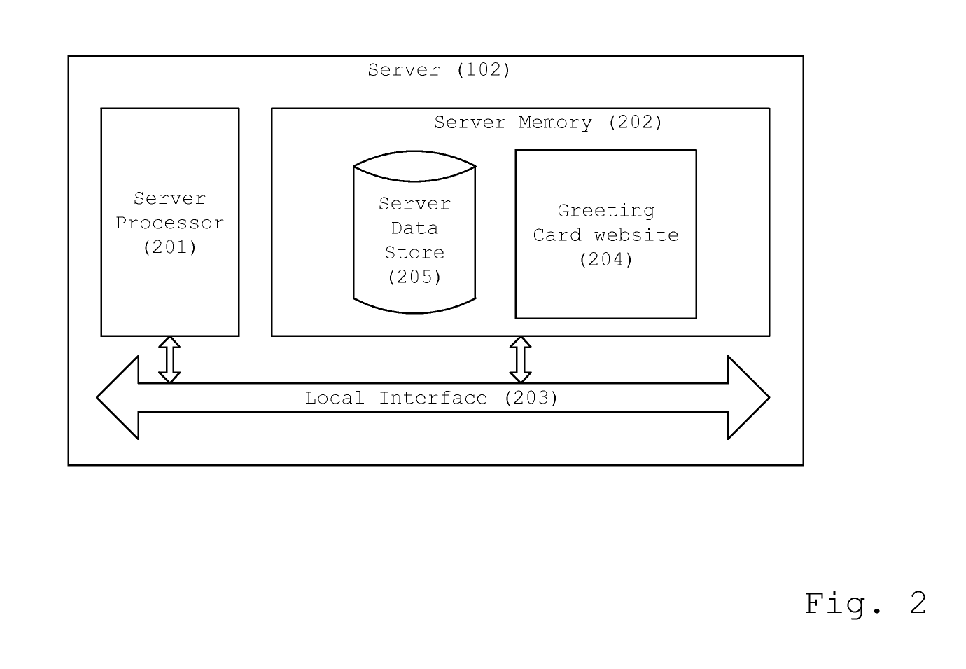

FIG. 2 illustrates a schematic diagram of server 102 according to an embodiment of the present disclosure. Server 102 can comprise a server processor 201, and a server memory 202 and a local interface 203. Local interface 203 can be a program that controls a display for the user, which can allow user to view and/or interact with server 102. Server processor 201 can be a processing unit that performs set of instructions stored within server memory 202. Server memory 202 can comprise a greeting card website 204, and a data storage 205. Greeting card website 204 can comprise business logic for server 102. In this embodiment, greeting card website 204 can contain HTML (Hyper Text Markup Language), scripts, and/or applications. Data storage 205 can be collections of data accessible through greeting card website 204. Further, greeting card website 204 can perform functions such as adding, transferring and retrieving information on data storage 205 using local interface 203.

Server 102 includes at least one processor circuit, for example, having server processor 201 and server memory 202, both of which are coupled to local interface 203. To this end, server 102 can comprise, for example, at least one server, computer or like device. Local interface 203 can comprise, for example, a data bus with an accompanying address/control bus or other bus structure as can be appreciated.

In particular, stored in the server memory 202 and executable by server processor 201 are greeting card website 204, and potentially other applications. Also stored in server memory 202 can be server data storage 205 and other data. In addition, an operating system can be stored in server memory 202 and executable by server processor 201.

It is understood that there can be other applications that are stored in server memory 202 and are executable by server processor 201 as can be appreciated. Where any component discussed herein is implemented in the form of software, any one of a number of programming languages can be employed such as, for example, C, C++, C#, Objective C, Java, Java Script, Perl, PHP, Visual Basic, Python, Ruby, Delphi, Flash, or other programming languages.

A number of software components can be stored in server memory 202 and can be executable by server processor 201. In this respect, the term “executable” means a program file that is in a form that can ultimately be run by server processor 201. Examples of executable programs can be, for example, a compiled program that can be translated into machine code in a format that can be loaded into a random access portion of server memory 202 and run by server processor 201, source code that can be expressed in proper format such as object code that is capable of being loaded into a random access portion of server memory 202 and executed by server processor 201, or source code that can be interpreted by another executable program to generate instructions in a random access portion of provider memory 202 to be executed by server processor 201, etc. An executable program can be stored in any portion or component of server memory 202 including, for example, random access memory (RAM), read-only memory (ROM), hard drive, solid-state drive, USB flash drive, memory card, optical disc such as compact disc (CD) or digital versatile disc (DVD), magnetic tape, network attached/addressable storage or other memory components.

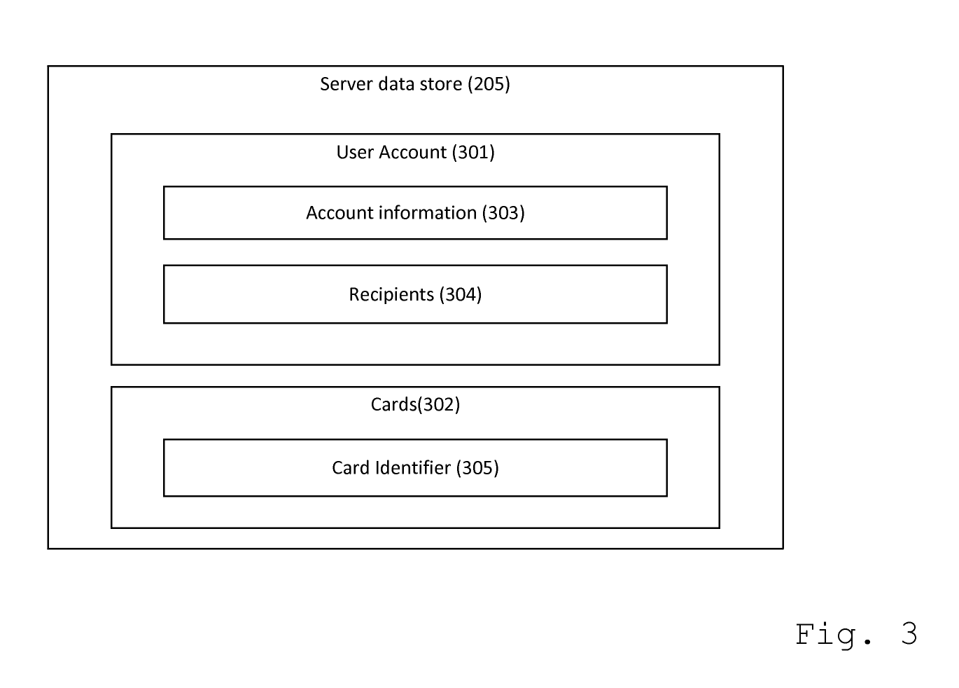

FIG. 3 illustrates server data store 205 comprising one or more user accounts 301, and a plurality of cards 302. In one embodiment, each user account 301 can be related to a user that is signed up on greeting card website 204. Each user account 301 can comprise account information 303 and one or more recipients 304. Account information 303 can comprise information on user account 301, which can include but is not limited to, name, username, password, billing information, and email address. Recipients 304 can be individuals that are related to a user, such as family members, friends, and/or co-workers. Cards 302 can be greeting cards in various types, and designs. Each card 302 can comprise a card identifier 305. Card identifier 305 can be a unique identification for each type and design of each card 302. Another example of cards 302 is a post card.

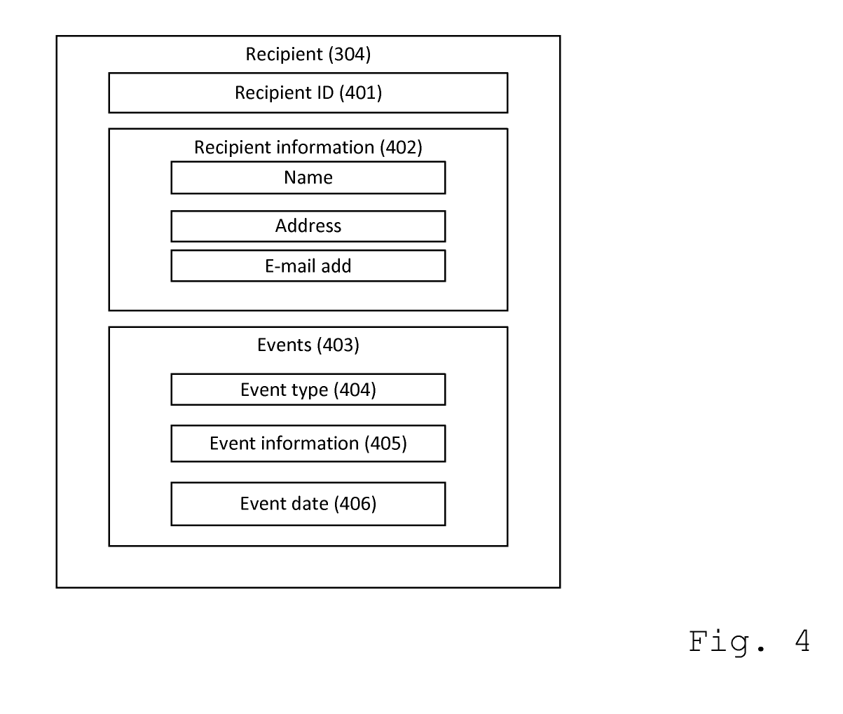

FIG. 4 illustrates each recipient 304 comprising a recipient (identification) ID 401, recipient information 402, and one or more events 403. Recipient ID 401 can be a unique identifier, which is automatically generated by the system for each recipient 304. Recipient information 402 can comprise information of an individual such as recipient's name, recipient's relation to a user, and recipient's address. Events 403 can comprise an event type 404, event information 405, and event date 406. Event type 404 can be an identifier associated with an event 403 such as birthdays, graduations, Christmas, etc. Moreover, event type 404 can be more specific, for example, son's birthday, wife's birthday, daughter's graduation, etc. In one embodiment, each event type 404 can be associated with one or more cards 302 through card identifier 305. Event information 405 can comprise details on each event 403 such as name of event. Event information 405 can be associated with one or more event type 404. Event date 406 can be the actual date of event 403.

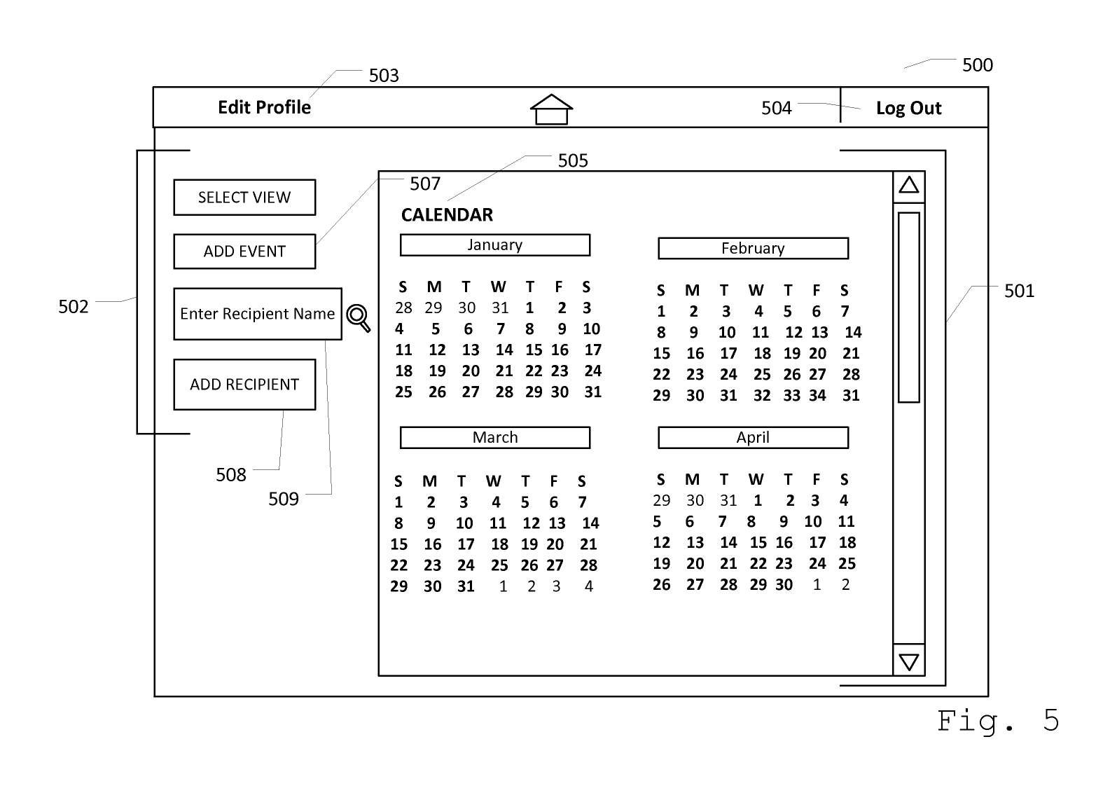

FIG. 5 illustrates a main screen 500 of greeting card website 204. In one embodiment, a user needs to register on greeting card website 204 to access main screen 500. As such, a user can supply required information such as username, password, and billing information. In another embodiment, a user can sign in on greeting card website 204 through entering the user's existing social website credentials such as the user's Facebook account username and password. In these embodiments, signing in on greeting card website 204 relates to creating user account 301 on server data storage 205. The page can display main screen 500 after logging in successfully on greeting card website 204. Main screen 500 can comprise a main window 501, a menu 502, an edit profile tool 503, and a logout button 504. Main window 501 can display a calendar 505 comprising lists of events related to a user, in one embodiment.

Further in an example embodiment, menu 502 can comprise an add event button 507, an add recipient button 508, and a recipient search box 509. Add event button 507 can be an interactive tool such as a link, button, or icon. Furthermore, add event button 507 can allow user to add events 403 for each recipient 304. Add recipient button 508 can allow user to add a new recipient 304. Recipient search box 509 can allow a user to search for recipients 304. This feature can allow a user a quick access to a specific recipient 304 when managing events 403, and/or managing recipient information 402.

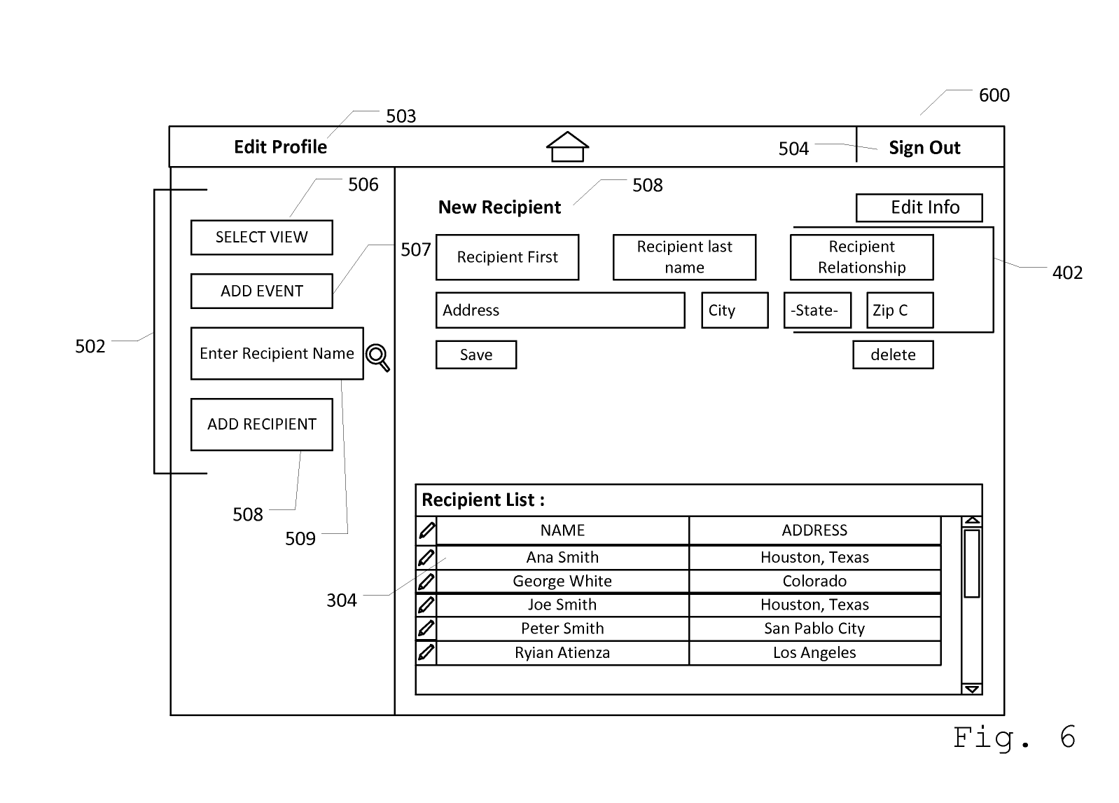

FIG. 6 illustrates a recipient screen 600. Clicking add recipient button 508 can display add recipient screen 600. Recipient screen 600 can allow a user to add, and/or manage each recipient 304 on server data store 205. Add recipient screen 600 can comprise fields for recipient information 402 that can include but are not limited to name of recipient, relationship of recipient to the user, and recipient address. In one embodiment, a user can also update, and remove recipient information 402 in recipient screen 600.

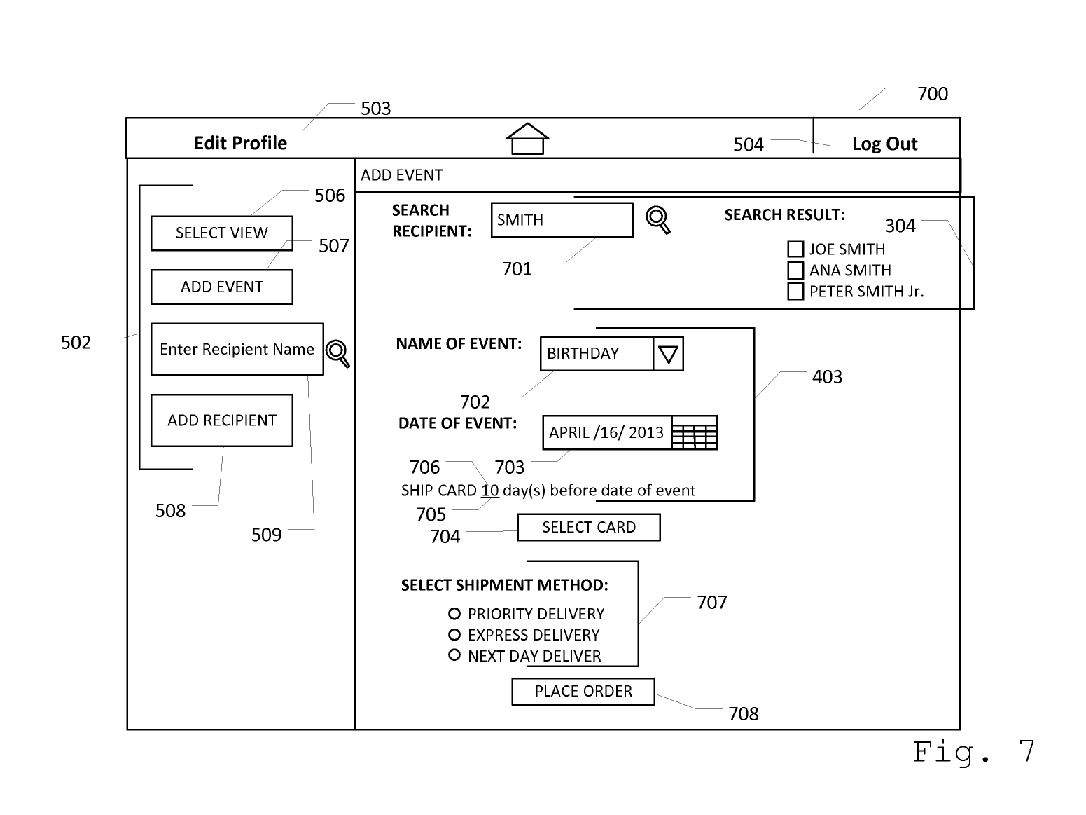

FIG. 7 illustrates an event screen 700. Clicking add event button 507 can display event screen 700. Event screen 700 can allow a user to associate recipient 304 to event 403. Event screen 700 can comprise a select recipient tool 701, an event name field 702, a select a date tool 703, a select a card tool 704, select a shipping method 707, and place order button 708. In one embodiment, select recipient tool 701 can be recipient search box 509. In such embodiment, a user can enter recipient information 402 such as recipient name, and then click on the search button to find a specific recipient 304. Next, the user can select a desired recipient 304 from the search result. In another embodiment, select recipient tool 701 can be a link or a button that opens up a page or a window to allow a user to select a specific recipient 304 from a recipient list. Event name field 702 can be a blank field that can allow a user to enter information that can aid in identifying the event, and/or occasion being celebrated, in one embodiment. In another embodiment, event name field 702 can be a dropdown list box that can allow a user to select event information 405. In this embodiment, selecting event information 405 from event name field 702 can relate to selecting event type 404. Select a date tool 703 can be a calendar icon, in one embodiment. Select a card tool 704 can be an interactive tool such as a link, a button, or an icon. In one embodiment, event screen 700 can further comprise a number of days field 705. Number of days field 705 can allow a user to set the number of days when card 302 will arrive to the user's address. In a preferred embodiment, number of days field 705 can have a default number of days 706 when card 302 is shipped to a user's address. In one example if default number of days 706 is 10 days then, card 302 can arrive at a user's supplied address 10 days prior event date 406. In such embodiment if a user failed or forgot to fill up number of days field 705, card 302 can still be sent to the user at default number of days 706 prior event date 406. In another embodiment, the user can supply his desired number of days before card 302 is shipped to his address on number of days field 705. Further, after entering number of days 706 the user can click on select a card tool 704 to select card 302. In one embodiment a new screen can be displayed to allow the user to select card 302, which is further discussed below. After card 302 is selected, the user can click on select a shipping method 707. Select a shipping method 707 can be an interactive tool such as a link, a button, or an icon. Select a shipping method 707 can allow the user to choose the type of shipment he prefers. In one embodiment, select a shipping method 707 can relate to selecting a lead-time and rates for the shipment of card 302, such as priority delivery, express delivery, or next day delivery. Lastly, the user can click on place order button 708 once all the required information, such as recipient 304, event type 404, and event date 406 is supplied. Clicking place order button 708 can relate to placing an order of the selected card 302 and adding event 403 on calendar 505. Once event 403 has been successfully added on greeting card website 204, created event 403 can be plotted in calendar 505. In one embodiment, the date associated to event 403 can be highlighted in calendar 505, which can indicate that the date comprises one or more event 403. This feature provides a user a quick way of determining important days by viewing calendar 505 on main screen 500.

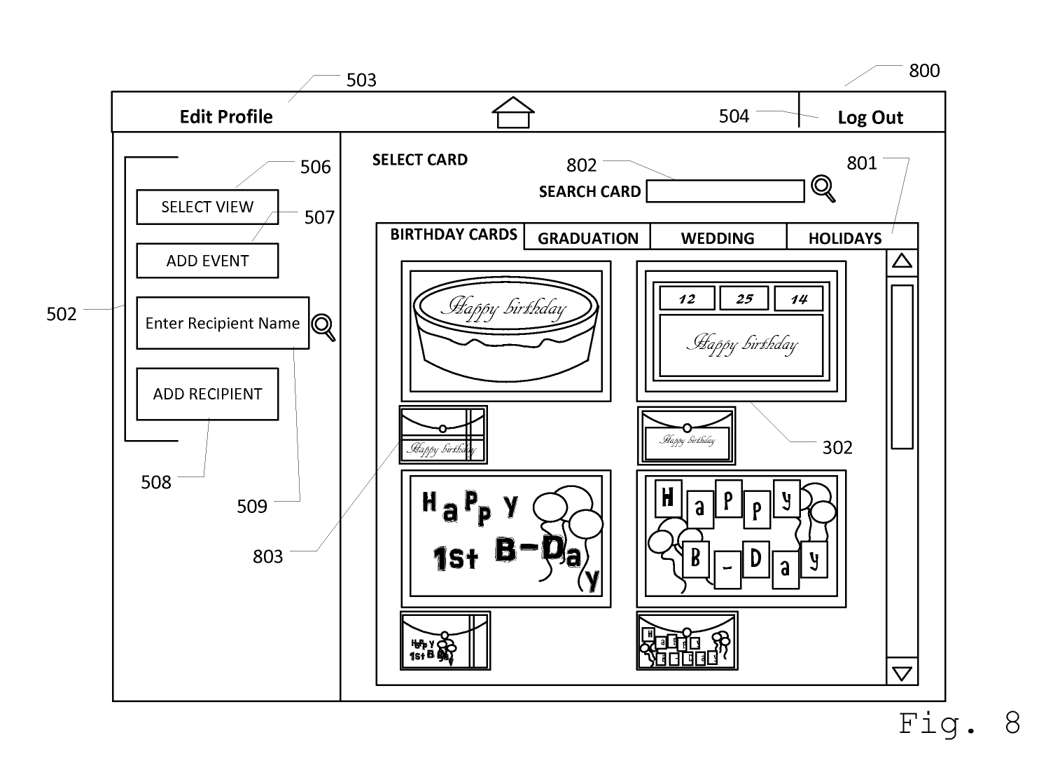

FIG. 8 illustrates a select card screen 800. Clicking select a card tool 704 from event screen 700 can display select card screen 800. In one embodiment, select card screen 800 can display cards 302 that are associated with event information 405, which was selected from event screen 700. Further in one embodiment, selecting card 302 can also comprise of selecting an envelope 803 to be used for card 302. As an example shown in FIG. 7, a user selected “birthday” on event name field 702. In such example, cards 302 that are associated with event type identifier 404 for event information 405 can be displayed on select card screen 800 after the user clicks select a card tool 704. In another embodiment, select card screen 800 can display entire collections of cards 302. In this embodiment, select card screen 800 can comprise one or more card categories tab 801, and a search card field 802. Card categories tab 801 can be displayed as a tab, a dropdown list box, a link, or a menu list. Card categories tab 801 can be variety of cards that are classified according to the type of events or occasions. In one embodiment, each card category tab 801 can be associated with event information 405. Search card field 802 can allow a user to enter a specific search criterion to filter the list of card selection on select card screen 800.

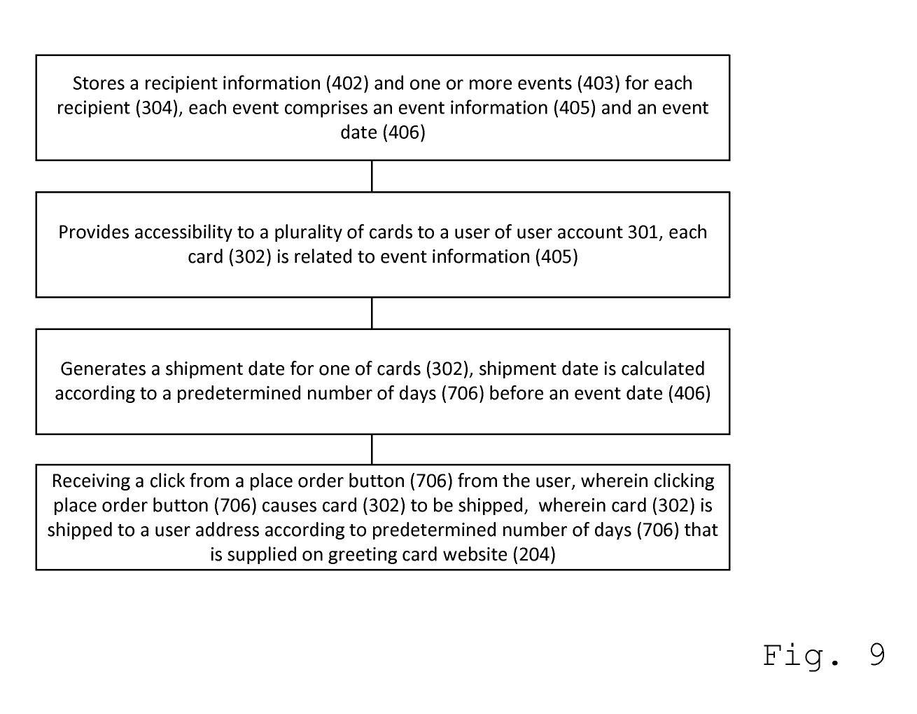

FIG. 9 illustrates an exemplary method of selecting card 302 from greeting card website 204. A user can access greeting card website 204 after registering on the website. Once signed in, the user can be brought to main screen 500 wherein the user can add, and/or manage recipients 304 and events 403. Initially, the user can store recipients 304 on greeting card website 204 through clicking on add recipient tool 508, and entering recipient information 402 on recipient screen 600. Next, the user can click on add event tool 507 to create events 403 to be associated to an existing recipient 304. Then, the user can supply, and/or select the information needed on event screen 700 such as recipient information 402, event information 405, date of event 406, and the number of dates when card 302 should be shipped to the user's address. In one embodiment, after supplying information on event screen 700, the user can click on select card tool 704 and then select a specific card 302 to be sent to the selected recipient 304. In another embodiment, a user can select event information 402 on event name field 702. Selected event information 405 can be associated to one or more cards 302 that is stored within greeting card website 204. In such embodiment, greeting card website 204 can select a specific card 302 in behalf of the end user. Greeting card website 204 can be capable of filtering and selecting card 302 based from event information 405 and recipient information 402 such as event type, event date, and relationship to user that was supplied by the user. After a specific card 302 is selected, greeting card website 204 can calculate a shipment date for the selected card 302. The shipment date can be calculated according to the number of days entered by the user on number of days field 705. The user can also click select shipment method 707 to choose the type of shipment method he prefers. After required information is supplied, the user can click on place order button 708. Clicking place order button 708 can be associated to purchasing card 302 selected. Furthermore, clicking place order button 708 can cause card 302 be shipped to the user according to the selected shipment method 707 selected and/or the number of days 706 entered on number of days field 705. The user can then expect card 302 be delivered on his supplied address according to the shipment method and/or number of days 706 he supplied on number of days field 705. In a preferred embodiment, the user can receive a package that comprises card 302 with envelope 803 that was selected by the user, and a sheet that contains the mailing address of the specific recipient 304. In this embodiment, the user can handwrite the address on envelope 803 and the message on card 302. In another embodiment, the address of the specific recipient 304 can be printed on envelope 803 of card 302. In some embodiments, the package can comprise a sticker with the address of specific recipient 304 printed on it. This can give the user an option to choose between sticking the sticker on card 302, or handwrite the address on card 302. Once completed, the user can drop card 302 in the mail or hand-deliver the card.

Server memory 202 can include both volatile and non-volatile memory and data storage components. Volatile components do not retain data values upon loss of power. Non-volatile components, on the other hand, retain data upon a loss of power. Thus, server memory 202 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, server processor 201 can represent multiple processors and multiple memories that operate in parallel processing circuits, respectively. In such a case, local interface 203 can be an appropriate network, including network 103 that facilitates communication between any of the multiple server processors 201, between any server processors 201 and any of the server memories 202, or between any two of the server memory 202, etc. Local interface 203 can comprise additional systems designed to coordinate this communication, including, but not limited to, performing load balancing. Server processor 201 can be of electrical or of some other available construction.

Although greeting card website 204 and multiple site server website 1104, and other various systems described herein can be embodied in software or code executed by general purpose hardware discussed above, greeting card website 204 can also be embodied in dedicated hardware or a combination of software/general purpose hardware and dedicated hardware. If embodied in dedicated hardware, each greeting card website 204 can be implemented as a circuit or state machine that employs a number of technologies. These technologies can include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 9 shows the functionality and operation of an implementation of portions of greeting card website 204. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as server processor 201 in a computer system or other system. The machine code can be converted from the source code, etc. If embodied in hardware, each block can represent a circuit or a number of interconnected circuits to implement the specified logical function(s).

Although the flowchart of FIG. 9 show a specific order of execution, the order of execution can differ from what is depicted. For example, the order of execution of two or more blocks can be rearranged relative to the order shown. Also, two or more blocks shown in succession in flowchart of FIG. 9 can be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. All such variations are within the scope of the present disclosure.

Also, any logic or application described herein that comprises software or code, including greeting card website 204, can be embodied in any computer-readable storage medium for use by or in connection with an instruction execution system such as, server processor 201 in a computer system or other system. The logic can comprise statements including instructions and declarations that can be fetched from the computer-readable storage medium and executed by the instruction execution system.

In the context of the present disclosure, a “computer-readable storage medium” can be any medium that can contain, store, or maintain the logic or application described herein for use by or in connection with the instruction execution system. The computer-readable storage medium can comprise any one of many physical media, such as electronic, magnetic, optical, electromagnetic, infrared, or semiconductor media. More specific examples of a suitable computer-readable storage medium can include, but are not limited to, magnetic tapes, magnetic floppy diskettes, magnetic hard drives, memory cards, solid-state drives, USB flash drives, or optical discs. Also, the computer-readable storage medium can be a random access memory (RAM), including static random access memory (SRAM), dynamic random access memory (DRAM) or magnetic random access memory (MRAM). In addition, the computer-readable storage medium can be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system that provides an automated generation and shipment of greeting cards comprising
a server memory that stores
a user account comprising a user address;
one or more recipients related to said user account;
a plurality of cards; and
a greeting card website; and
a server processor that, according to instructions from said greeting card website
stores a recipient information and one or more events for each of said recipients, each of said events comprising an event information and an event date;
provides accessibility to said cards to a user of said user account, each of said cards related to said event information; and
generates a shipment date for one of said cards, said shipment date calculated according to a predetermined number of days before an event date; and
receiving a click from a place order button from said user, wherein clicking place order button causes said card to be shipped, further wherein said card is shipped to said user address according to said predetermined number of days that is supplied on said greeting card website.

2. The system of claim 1 wherein said server processor is capable of selecting one of said cards based from said event information and said recipient information that was supplied by said user.

3. The system of claim 1 wherein said server processor is capable of providing a calendar, said calendar comprises each of said events created for each of said recipients on said user account.

4. The system of claim 1 wherein said predetermined number of days is supplied by said user on said greeting card website.

5. The system of claim 1 wherein said predetermined number of days is defaulted to 10 days.

6. The system of claim 1 wherein said card is a greeting card.

7. The system of claim 1 wherein said card is a post card.

8. The method for providing an automated generation and shipment of greeting cards to a user comprising the steps
storing a recipient information and one or more events for each of one or more recipients, each of said events comprising an event information and an event date;
providing accessibility to a plurality of cards to said user of a user account, each of said cards related to said event information; and
generating a shipment date for one of said cards, said shipment date calculated according to a predetermined number of days before an event date; and
receiving a click from a place order button from said user, wherein clicking said place order button causes said card to be shipped, further wherein said card is shipped to a user address according to said predetermined number of days that is supplied on said greeting card website.

9. The method of claim 8 wherein said card shipped to said user comprises a sheet containing the address of said recipient.

10. The method of claim 8 wherein said card shipped to said user comprises an envelope with printed address of said recipient.

11. The method of claim 8 wherein said card shipped to said user comprises a sticker with printed address of said recipient.

12. The method of claim 8, comprising the step of signing in on said greeting card website by said user.

13. The method of claim 9, prior to signing in on said greeting card website comprising the step or registering on said greeting card website by supplying said user's credential.

14. The method of claim 9, prior to signing in on said greeting card website comprising the step of entering said users existing social website credentials.

15. The method of claim 11 wherein said social website credentials is a Facebook account.

16. The method of claim 8, comprising the steps of selecting one of said cards based from said event information and said recipient information that was supplied by said user.

17. The method of claim 8 wherein said server processor is capable of providing a calendar, said calendar comprises each of said events created for each of said recipients on said user account.

18. The method of claim 8 wherein said predetermined number of days is supplied by said user on said greeting card website.

19. The method of claim 8 wherein said predetermined number of days is defaulted to 10 days.

20. A computer readable storage medium having a computer readable program code embodied therein, wherein the computer readable program code is adapted to be executed to implement the method of claim 1.
